(19) United States
(12) Patent Application Publication
(10) Pub. No.: US 2015/0251208 A1
(43) Pub. Date: Sep. 10, 2015

(54) DISCHARGE SYSTEM

(71) Applicant: HEISHIN LTD., Kobe-shi, Hyogo (JP)

(72) Inventor: Yusuke Tanaka, Hyogo (JP)

(73) Assignee: HEISHIN LTD., Hyogo (JP)

(21) Appl. No.: 14/433,021

(22) PCT Filed: Oct. 1, 2013
(86) PCT No.: PCT/JP2013/076750

§ 371 Date: Apr. 1, 2015

(30) Foreign Application Priority Data
Oct. 1, 2012 (JP) 2012-219345

(51) Int. Cl. B05C 11/10; B05C 5/02

(52) U.S. Cl. CPC B05C 11/1002; B05C 5/0225

(57) ABSTRACT

When a discharge device and a filling device are connected to each other so as to fill a fluid into the discharge device, the mixing of air into the fluid is suppressed, and thereby a discharge failure caused by the mixing of air is suppressed. A discharge system includes a discharge device capable of being filled with and discharging a fluid for discharge, a filling device for filling the fluid into the discharge device, a connecting device for connecting the discharge device and the filling device to each other in a separable manner, a sealed space forming member for forming a sealed space, and a decompression device for bringing an inside of the sealed space into a negative pressure state.

### TECHNICAL FIELD

The present invention relates to a discharge system that can be used for purposes of applying a fluid, such as a sealant or an adhesive, to various components in an automobile assembly plant or the like, filling a fluid, such as grease, into a container, and the like.

### BACKGROUND ART

Hitherto, an application device and method for a functional fluid disclosed in Patent Literature 1, a joint for a fluid and an application device disclosed in Patent Literature 2, or the like are used for purposes of applying a fluid, such as a sealant or an adhesive, to various components in an automobile assembly plant or the like. The application device according to Patent Literature 1 includes an application unit and a filling unit. In this application device, the application unit includes a discharge gun for discharging a functional fluid and a feeder for feeding the functional fluid to the discharge gun. Further, the filling unit fills the functional fluid into a filling cylinder through a filling port. With such a configuration, a pipe having a long distance for feeding the functional fluid up to the discharge gun is made unnecessary to significantly shorten the length of the pipe, and a temperature regulator for regulating the temperature of the fluid and a fluid feed pump are limited to the minimum requirement.

Further, the joint for a fluid and the application device disclosed in Patent Literature 2 also aim at making it unnecessary to use a large-scale pipe facility for feeding a fluid from a tank to a discharger and a high-pressure pump for transferring the fluid in the same way as in Patent Literature 1. In the related art of Patent Literature 2, there are provided first to third feed portions for feeding a fluid, such as a sealant, and first to third dischargers mounted in a removable manner on the respective first to third feed portions and the like through intermediation of joints for a fluid. Further, each of the first to third dischargers includes a tank for storing the fluid fed from the corresponding feed portion on which the discharger is mounted, and thus the fluid in the tank can be discharged. Further, each of the first to third dischargers can be mounted in a removable manner on a robot arm through intermediation of a second joint.

### CITATION LIST

### Patent Literature

[PTL 1] JP 2004-154733 A

[PTL 2] JP 2007-275769 A

### SUMMARY OF INVENTION

### Technical Problem

As described above, there have been provided various discharge systems in which a discharge device for discharging a fluid for discharge and a filling device for filling the fluid into the discharge device are provided so as to be connected to and separated from each other, and the fluid can be filled into the discharge device side from the filling device side by connecting the discharge device and the filling device to each other. In the above-mentioned related-art discharge system, there is a risk in that, when the discharge device and the filling device are connected to each other so as to fill the fluid into the discharge device, air may be mixed into an inside of a filling system of the fluid. Further, in the case where air is mixed into the fluid, an application failure occurs when the fluid is discharged from the discharge device to be applied to various components and the like. However, in the related-art discharge system, the mixing of air into the fluid is not taken into consideration, and thus sufficient countermeasures have not been taken.

In view of the above-mentioned circumstances, it is an object of the present invention to provide a discharge system capable of minimizing a discharge failure caused by the mixing of air by suppressing the mixing of air into a fluid when connecting a discharge device and a filling device to each other so as to fill the fluid into the discharge device.

### Solution to Problem

In order to solve the above-mentioned problem, according to one embodiment of the present invention, there is provided a discharge system, including: a discharge device capable of discharging a fluid; and a filling device capable of filling the fluid into the discharge device, the discharge system being capable of filling the fluid into the discharge device side from the filling device side by connecting a discharge-side connector mounted on the discharge device side and a filling-side connector mounted on the filling device side to each other in a negative pressure environment.

In the discharge system according to one embodiment of the present invention, when the fluid is filled into the discharge device, a connecting operation of the discharge-side connector and the filling-side connector is performed in the negative pressure environment. Therefore, according to the discharge system of the one embodiment of the present invention, when the discharge device and the filling device are connected to each other, the mixing of air in the fluid may be suppressed. Thus, according to the discharge system of the one embodiment of the present invention, a discharge failure of the fluid caused by the mixing of air into the fluid may be suppressed.

The discharge system according to the one embodiment of the present invention may further include: a sealed space forming member capable of forming a sealed space by causing the discharge-side connector and the filling-side connector to be inserted into the sealed space forming member; and a decompression device for decompressing an inside of the sealed space. The discharge-side connector and the filling-side connector may be capable of being connected to each other under a state in which the inside of the sealed space is brought into the negative pressure environment by the decompression device.

According to the above-mentioned configuration, the discharge-side connector and the filling-side connector may be connected to each other accurately and smoothly in the negative pressure environment. With this, a discharge failure of the fluid caused by the mixing of air into the fluid may be further suppressed.

In the discharge system according to the one embodiment of the present invention, it is desired that the discharge device and/or the filling device include a buffer for buffering an internal pressure variation caused by connection and/or separation of the discharge device and the filling device.

In the case where the discharge device and the filling device can be connected to and separated from each other so as to fill the fluid into the discharge device as in the discharge system according to the one embodiment of the present invention, an internal pressure variation is assumed in a pipe and the like provided in the discharge device and the filling device during the connecting and separating operations. When the internal pressure in the discharge device or the filling device becomes a negative pressure, there is a risk in that air may enter the discharge device or the filling device from outside. In order to eliminate such a risk, according to one embodiment of the present invention, a buffer is provided in one or both of the discharge device and the filling device, to thereby buffer an internal pressure variation caused by the connecting and separating operations of the discharge device and the filling device. With this, the entry of air into the discharge device and the filling device during the connecting and separating operations of the discharge device and the filling device may be further reliably suppressed. Thus, according to the discharge system of the one embodiment of the present invention, a discharge failure of the fluid caused by the mixing of air may be further suppressed.

In the discharge system according to the one embodiment of the present invention, the buffer may include an absorber mechanism including a casing, a piston mounted in the casing in a slidable manner, and biasing means for biasing the piston. An inside of the casing may be partitioned by the piston into a first chamber and a second chamber that allows outflow and inflow of the fluid, and the piston may be biased by the biasing means in a direction of reducing a capacity of the second chamber.

According to the above-mentioned configuration, such a situation may be avoided that insides of the discharge device and the filling device are brought into a negative pressure during the connecting and separating operations of the discharge device and the filling device. With this, a phenomenon may be suppressed in which air enters the discharge device and the filling device to cause a discharge failure of the fluid. Thus, according to the discharge system of the one embodiment of the present invention, a discharge failure of the fluid caused by the mixing of air may be further reliably suppressed.

In the discharge system according to the one embodiment of the present invention, the buffer may include a cylinder mechanism including a casing, a piston mounted in the casing in a slidable manner, and a driving source for slidably driving the piston. An inside of the casing may be partitioned by the piston into a first chamber and a second chamber that allows outflow and inflow of the fluid, and a capacity of the second chamber may be capable of being varied by operating the driving source.

According to the above-mentioned configuration, such a situation may be suppressed that the insides of the discharge device and the filling device are brought into a negative pressure during the connecting and separating operations of the discharge device and the filling device, to thereby suppress the mixing of air. Thus, according to the discharge system of the one embodiment of the present invention, a discharge failure of the fluid caused by the mixing of air may be further reliably suppressed.

Further, in the discharge system according to the one embodiment of the present invention, the buffer may include a tank capable of allowing outflow and inflow of the fluid.

According to the above-mentioned configuration, such a situation may be suppressed that the insides of the discharge device and the filling device are brought into a negative pressure during the connecting and separating operations, to thereby reliably suppress a discharge failure of the fluid caused by the entry of air.

In the discharge system according to the one embodiment of the present invention, it is desired that the discharge system further include a separation preventing mechanism for preventing separation of the discharge device connected to the filling device.

According to the above-mentioned configuration, even when the fluid is pumped from the filling device side to the discharge device side after the connection of the filling device side and the discharge device, the discharge device may be prevented from being separated from the filling device.

Further, in the discharge system according to the one embodiment of the present invention, it is desired that the discharge device include a uniaxial eccentric screw pump including: an external thread-shaped rotor that receives power to rotate eccentrically; and a stator having an inner circumferential surface formed into an internal thread shape.

In the discharge system of the one embodiment of the present invention, the discharge device includes the uniaxial eccentric screw pump, and hence the fluid may be discharged quantitatively and stably without pulsating and the like. Further, as described above, the discharge system of the one embodiment of the present invention may feed the fluid to the uniaxial eccentric screw pump forming the discharge device so that the fluid may be discharged while minimizing the entry of air. Thus, according to the one embodiment of the present invention, the discharge system may be provided, which exhibits extremely excellent characteristics in terms of discharge performance of the fluid.

### Advantageous Effects of Invention

According to the one embodiment of the present invention, it is possible to provide the discharge system capable of suppressing a discharge failure caused by the mixing of air by suppressing the mixing of air into a fluid when connecting the discharge device and the filling device to each other so as to fill the fluid into the discharge device.

### BRIEF DESCRIPTION OF DRAWINGS

FIG. 1 is an explanatory diagram illustrating an overview of a discharge system according to an embodiment of the present invention.

FIG. 2 are views each illustrating a discharge device adopted in the discharge system of FIG. 1. FIG. 2(a), 2(b), 2(c), 2(d), and 2(e) are a left side view, a front view, a sectional view, a plan view, and a perspective view, respectively.

FIG. 3 are views each illustrating a discharge-side buffer portion adopted in the discharge device of FIG. 2. FIG. 3(a), 3 (b), 3(c), and 3 (d) are a front view, a sectional view, a perspective view, and a plan view, respectively.

FIG. 4 is a sectional view illustrating a structure of a discharge portion adopted in the discharge device of FIG. 2.

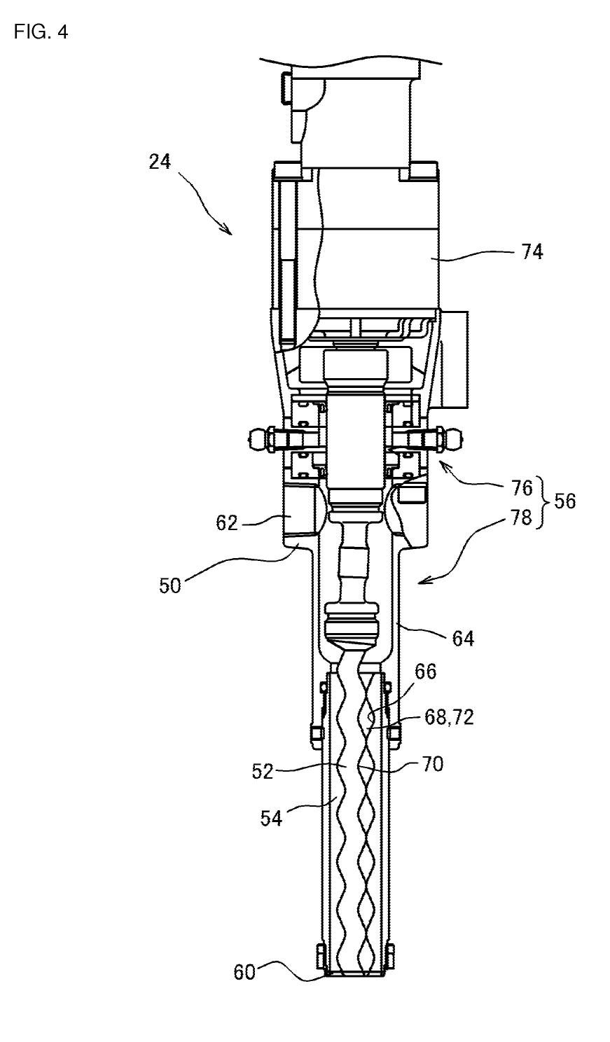

FIG. 5 is an exploded perspective view of a filling device adopted in the discharge system of FIG. 1.

FIG. 6 are views each illustrating a region of the filling device of FIG. 5 excluding a sealed space forming member. FIG. 6(a), 6(b), 6(c), and 6(d) are a front view, a right side view, a plan view, and a sectional view, respectively.

FIG. 7 is a flowchart illustrating an operation of the discharge system of FIG. 1.

FIG. 8 is a timing chart illustrating the operation of the discharge system of FIG. 1.

FIG. 9 are views each illustrating a first stage of the operation of the discharge system of FIG. 1. FIG. 9(a), 9(b), and 9(c) are a side view, a sectional view in a state viewed from the front, and a front view, respectively.

FIG. 10 are views each illustrating a second stage of the operation of the discharge system of FIG. 1. FIGS. 10(a), 10(b), and 10(c) are a side view, a sectional view in a state viewed from the front, and a front view, respectively.

FIG. 11 are views each illustrating a third stage of the operation of the discharge system of FIG. 1. FIGS. 11(a), 11(b), and 11(c) are a side view, a sectional view in a state viewed from the front, and a front view, respectively.

FIGS. 12 (a) and 12 (b) are respectively plan views in a fourth stage and a fifth stage of the operation of the discharge system of FIG. 1; FIGS. 12(c) and 12(d) are respectively enlarged views illustrating a state of a separation preventing mechanism in the fourth stage and the fifth stage of the operation; and FIGS. 12 (e) and 12(f) are respectively sectional views in the fourth stage and the fifth stage of the operation.

FIG. 13 is a perspective view illustrating a state in which the discharge device and the filling device are connected to each other in the discharge system of FIG. 1.

FIG. 14 are views each illustrating a first modified example of the discharge device illustrated in FIG. 2. FIGS. 14(a), 14(b), and 14(c) are a left side view, a front view, and a perspective view, respectively.

FIG. 15 are views each illustrating a second modified example of the discharge device illustrated in FIG. 2. FIGS. 15(a), 15(b), 15(c), and 15(d) are a left side view, a front view, a sectional view, and a perspective view, respectively.

FIG. 16 are views illustrating a connecting operation of the discharge device and the filling device illustrated in FIG. 15 on a step-by-step basis. FIGS. 16(a), 16(b), 16(c), and 16(d) illustrate a state of the discharge device and the filling device when viewed from a left side. FIGS. 16(e), 16(f), 16(g), and 16(h) are respectively enlarged sectional views of main portions of FIGS. 16(a), 16(b), 16(c), and 16(d). FIG. 16(i) is a perspective view illustrating a state in which the discharge device and the filling device are connected to each other.

### DESCRIPTION OF EMBODIMENTS

<<Regarding Device Configuration of Discharge System 10>>

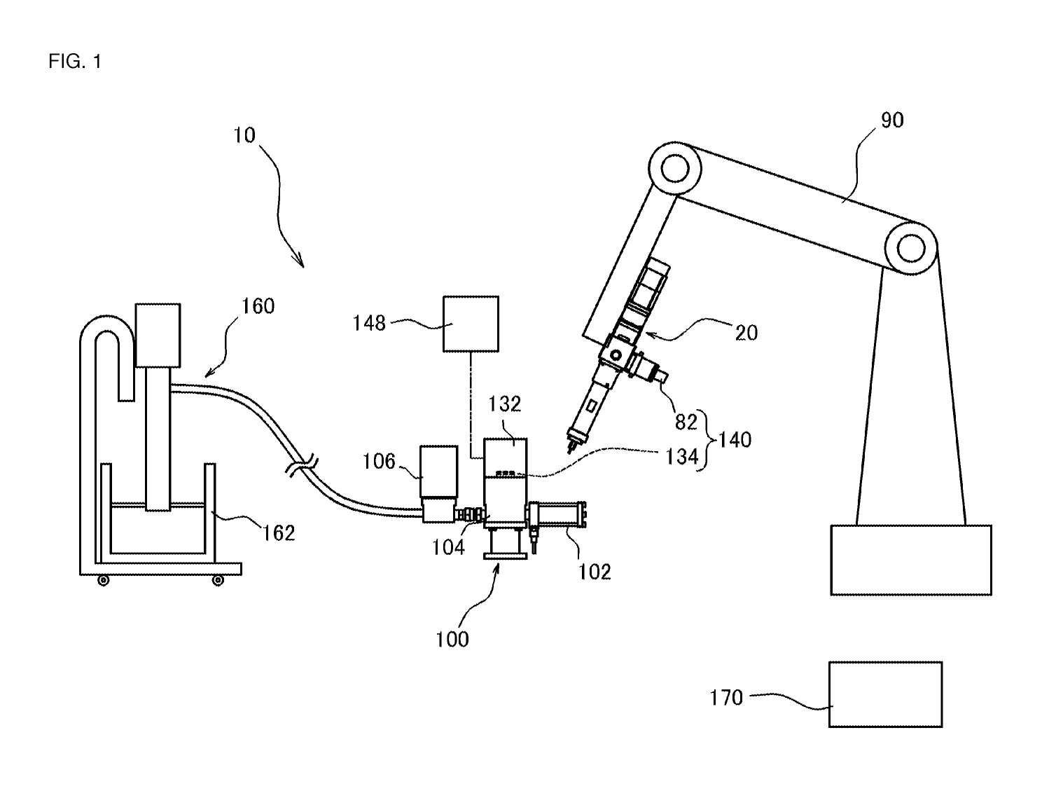

Now, a discharge system 10 according to an embodiment of the present invention is described in detail with reference to the drawings. As illustrated in FIG. 1, the discharge system 10 includes, as main components, a discharge device 20, a filling device 100, a fluid feed source 160, and a control device 170. The discharge system 10 can fill a fluid fed from the fluid feed source 160 into the discharge device 20 by connecting the discharge device 20 to the filling device 100. Further, the discharge system 10 can discharge the fluid filled in the discharge device 20 for application or the like by operating the discharge device 20 in a state of being separated from the filling device 100. That is, the discharge system 10 has such a system configuration that, in a state in which a pipe, a hose, or the like for feeding the fluid is not connected to the discharge device 20, the discharge device 20 is operated independently from the filling device 100 and the fluid feed source 160 so that the fluid can be applied or the like.

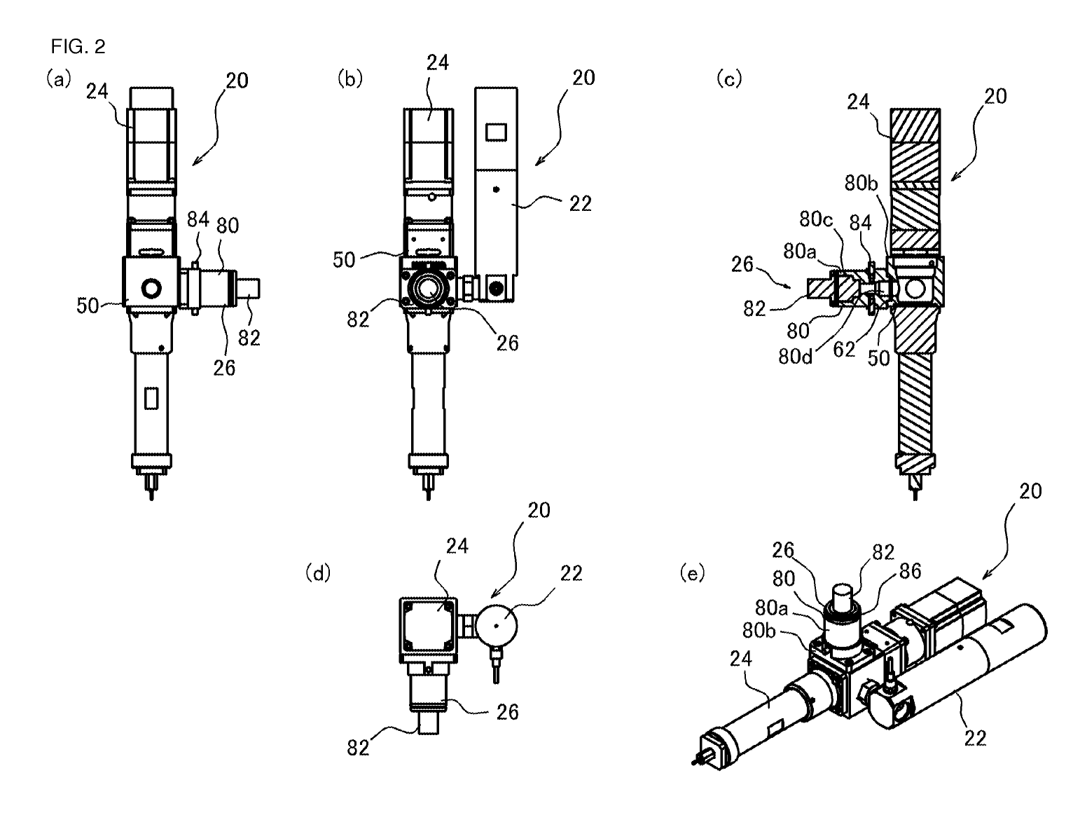

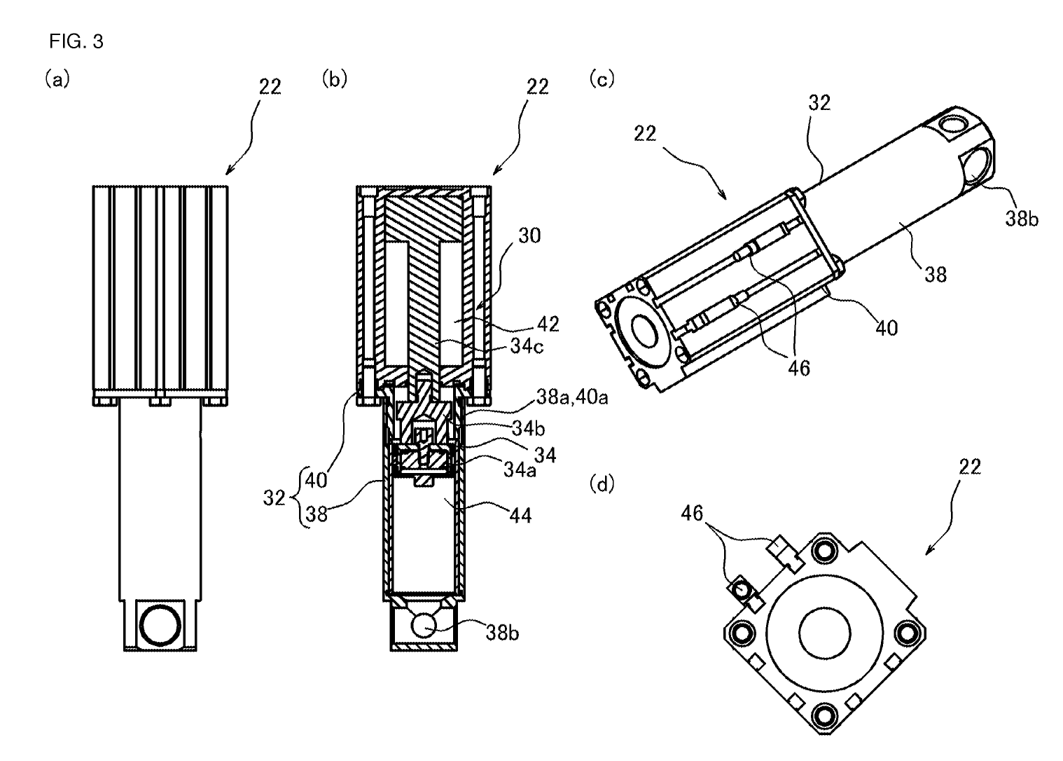

As illustrated in FIG. 2, the discharge device 20 includes a discharge-side buffer portion 22 (buffer), a discharge portion 24, and a discharge-side mounting/demounting portion 26. The discharge-side buffer portion 22 is provided to buffer an internal pressure variation in the discharge device 20, which is caused when the discharge device 20 and the filling device 10 are connected to and separated from each other so as to fill a fluid for discharge into the discharge portion 24. The discharge-side buffer portion 22 can be formed of a container, such as a tank, and in this embodiment, the discharge-side buffer portion 22 including a cylinder mechanism 30 as illustrated in FIG. 3 is adopted.

Specifically, as illustrated in FIG. 3(b), the discharge-side buffer portion 22 includes the cylinder mechanism 30 formed of a so-called air cylinder. The cylinder mechanism 30 includes a casing 32 and a piston 34. As illustrated in FIG. 3(c), the discharge-side buffer portion 22 can feed compressed air from an air feed source serving as a driving source.

As illustrated in FIG. 3 (b), the casing 32 is a container formed of a combination of a lower casing 38 and an upper casing 40. In connected portions between the lower casing 38 and the upper casing 40, an internal thread 38a and an external thread 40a are formed, respectively, and the casing 32 is assembled by screwing the internal thread 38a and the external thread 40a to each other. Further, in a lower end portion (on an opposite side to the internal thread 38a) of the lower casing 38, a connecting portion 38b is formed.

In the casing 32, the piston 34 can freely slide in an axis line direction of the casing 32. The piston 34 has such a configuration that a piston rod 34c is connected to a piston main body 34a through intermediation of a piston adaptor 34b. The piston 34 partitions a space in the casing 32 into a first chamber 42 on the upper casing 40 side and a second chamber 44 on the lower casing 38 side. The first chamber 42 is a compartment into which the compressed air fed from the air feed source serving as the driving source is introduced through ports 46 formed in the casing 32, and the second chamber 44 is a compartment that allows outflow and inflow of the fluid. The cylinder mechanism 30 can change the capacity of the second chamber 44 by operating the driving source. The second chamber 44 communicates to the connecting portion 38b so as to allow outflow and inflow of the fluid with respect to the second chamber 44 through the connecting portion 38b.

Further, in the discharge buffer portion 22, filled amount detection means (not shown) for detecting a filled amount based on the position of the piston 34 is provided. The filled amount detection means may be formed of any member. Specifically, as the filled amount detection means, an automatic switch may be adopted, in which a contact point is switched between an ON state and an OFF state based on entering and leaving of a magnet (not shown) provided in the piston 34 with respect to a detection range, and the automatic switch may be provided at an upper limit position and a lower limit position of a movable range of the piston 34. Alternatively, a pressure sensor capable of detecting an internal pressure in the discharge buffer portion 22 can be adopted as the filled amount detection means. In this case, an upper limit value and a lower limit value of the internal pressure are defined in advance. When the internal pressure reaches the upper limit value, it can be determined that the piston 34 has reached an upper limit position, and when the internal pressure reaches the lower limit value, it can be determined that the piston 34 has reached an upper limit position.

The discharge portion 24 is formed of a rotary displacement pump. In this embodiment, the discharge portion 24 is formed of a so-called uniaxial eccentric screw pump. The discharge portion 24 has such a configuration that a rotor 52, a stator 54, a power transmission mechanism 56, and the like are accommodated in a casing 50. The casing 50 is a tubular member made of a metal and has a first opening 60 on one end side in a longitudinal direction. Further, a second opening 62 is formed in an outer circumferential portion of the casing 50. The second opening 62 communicates to an inner space of the casing 50 in an intermediate portion 64 located in an intermediate part in the longitudinal direction of the casing 50.

The first opening 60 and the second opening 62 respectively serve as a suction port and a discharge port of the uniaxial eccentric screw pump forming the discharge portion 24. The first opening 60 and the second opening 62 of the discharge portion 24 are allowed to serve as the discharge port and the suction port, respectively, by rotating the rotor 52 in a forward direction. Further, the first opening 60 and the second opening 62 are allowed to serve as the suction port and the discharge port, respectively, by rotating the rotor 52 in a backward direction for maintenance and the like, and thus the inner space of the casing 50 and the like can be cleaned and the like.

The stator 54 is a member formed of an elastic body, such as a rubber, a resin, or the like, having a substantially cylindrical outer appearance. An inner circumferential wall 66 of the stator 54 is formed into a single-stage or multistage internal thread shape with “n” starts. In this embodiment, the stator 54 is formed into a multistage internal thread shape with two starts. Further, a through hole 68 of the stator 54 is formed so that a sectional shape (opening shape) becomes a substantially oval shape in a sectional view at any position in the longitudinal direction of the stator 54.

The rotor 52 is a shaft member made of a metal and is formed into a single-stage or multistage external thread shape with (n−1) starts. In this embodiment, the rotor 52 is formed into an eccentric external thread shape with a single start. The rotor 52 is formed so that a sectional shape becomes a substantially true circle shape in a sectional view at any position in the longitudinal direction of the rotor 52. The rotor 52 is inserted in the through hole 68 formed in the stator 54 so that the rotor 52 can freely rotate eccentrically in the through hole 68.

When the rotor 52 is inserted in the stator 54, an outer circumferential wall 70 of the rotor 52 and the inner circumferential wall 66 of the stator 54 are brought into close contact with each other at tangents of both the rotor 52 and the stator 54, and thereby a fluid conveyance path 72 (cavity) is formed between the inner circumferential wall 66 of the stator 54 and the outer circumferential wall 70 of the rotor 52. The fluid conveyance path 72 extends in a helical shape in the longitudinal direction of the stator 54 and the rotor 52.

When the rotor 52 is rotated in the through hole 68 of the stator 54, the fluid conveyance path 72 proceeds in the longitudinal direction of the stator 54 while rotating in the stator 54. Therefore, when the rotor 52 is rotated, the fluid is sucked into the fluid conveyance path 72 from one end side of the stator 54, and the fluid can be transferred toward the other end side of the stator 54 while being confined in the fluid conveyance path 72 and discharged to the other end side of the stator 54.

The power transmission mechanism 56 transmits power from a driving device 74 to the rotor 52. The power transmission mechanism 56 includes a power transmission portion 76 and an eccentric rotation portion 78. The power transmission portion 76 is formed on one end side in the longitudinal direction of the casing 50. Further, the eccentric rotation portion 78 is formed in the intermediate portion 64. The eccentric rotation portion 78 connects the power transmission portion 76 and the rotor 52 to each other so that power can be transmitted. The eccentric rotation portion 78 includes a coupling shaft 98 formed of a related-art well-known coupling rod, a screw rod, or the like. Therefore, the eccentric rotation portion 78 can transmit rotation power generated by the operation of the driving device 74 to the rotor 52, to thereby rotate the rotor 52 eccentrically.

As illustrated in FIG. 2, the discharge-side mounting/demounting portion 26 is connected to the casing 50 forming the discharge portion 24. As illustrated in FIGS. 2(c) and 2(d), the discharge-side mounting/demounting portion 26 has such a configuration that a discharge-side connector 82 and a pin 84 are mounted on a discharge-side mounting/demounting portion main body 80. The discharge-side mounting/demounting portion main body 80 has such a configuration that a rectangular connecting portion 80b is formed on a base end section of a cylindrical tubular portion 80a. A fitting portion 80c for allowing the discharge-side connector 82 to be fitted therein is formed on a tip end side of the tubular portion 80a. Further, a communication path 80d is formed in the tubular portion 80a so as to pass through the tubular portion 80a from the fitting portion 80c to the connecting portion 80b. The discharge-side mounting/demounting portion main body 80 is mounted on the casing 50 in a state of being positioned so that the communication path 80d and the second opening 62 formed in the discharge portion 24 communicate to each other. A sealing member 86, such as an O-ring, is mounted on an outer circumferential portion on the tip end side of the tubular portion 80a.

As described later in detail, the discharge-side connector 82 is combined with a filling-side connector 134 provided in the filling device 100, to thereby form a connecting device 140 for connecting the discharge device 20 and the filling device 100 to each other. The discharge-side connector 82 is a male plug to be plugged into the filling-side connector 134. The discharge-side connector 82 is fitted into the fitting portion 80c formed in the tubular portion 80a of the discharge-side mounting/demounting portion main body 80 so as to communicate to the communication path 80d.

As described later in detail, the pin 84 is combined with a hook-like slit 144 formed on the filling device 100 side to form a separation preventing mechanism 150. The pin 84 is used for positioning the discharge device 20 and the filling device 100 when connecting the discharge device 20 and the filling device 100 to each other so that the separation of the discharge device 20 and the filling device 100 is suppressed. The pin 84 is provided so as to protrude in a substantially vertical direction with respect to the outer circumferential surface of the tubular portion 80a at a position on the base end side (connecting portion 80b side) of the tubular portion 80a. Two pins 84 are provided on the tubular portion 80a at an interval of about 180° in the circumferential direction.

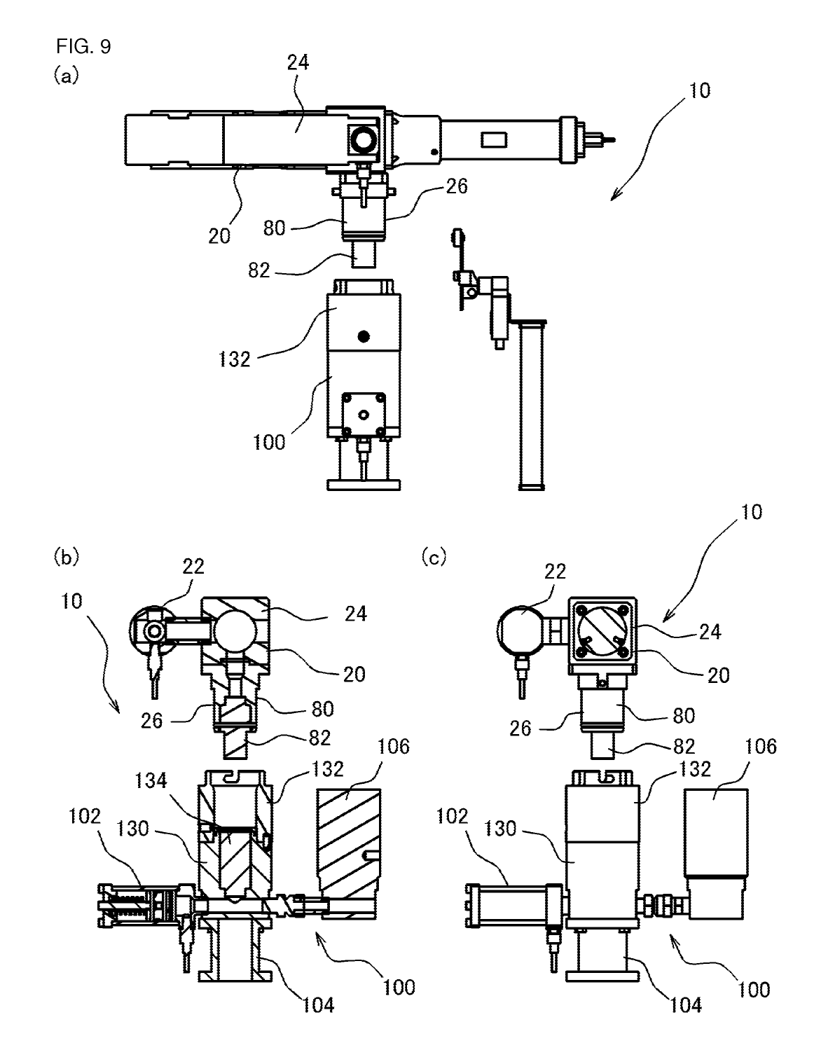

As illustrated in FIG. 1, the discharge device 20 is mounted on a manipulator 90 having a degree of freedom of a plurality of axes as in a so-called articulated robot or the like. Therefore, the fluid can be applied to various components and the like in accordance with an application pattern of the fluid defined in advance by causing the discharge device 20 to discharge the fluid while moving the discharge device 20 with the manipulator 90. Further, the discharge device 20 and the filling device 100 can be connected to each other by moving the discharge device 20 with the manipulator 90 in the order illustrated in FIGS. 9 to 12 and the like and bringing the discharge-side connector 82 close to the filling-side connector 134 described later in detail in a state of positioning the discharge-side connector 82 and the filling-side connector 134. The discharge device 20 and the filling device 100 can be separated from each other by performing an operation opposite to the foregoing.

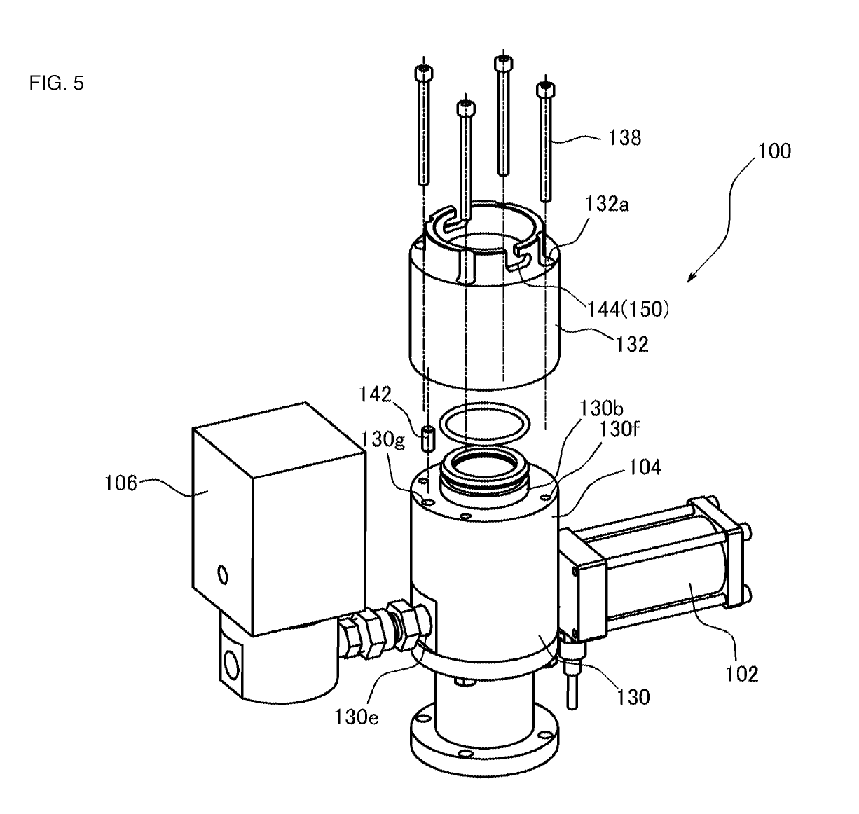

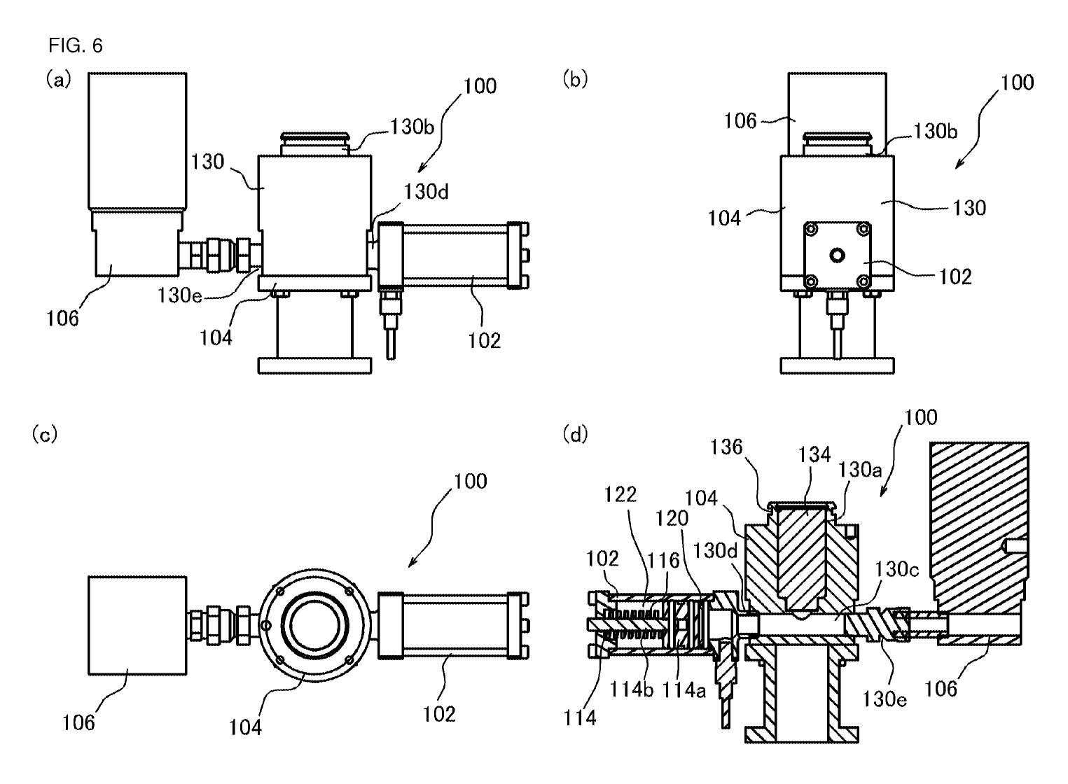

The filling device 100 serves as a filling station for filling the fluid into the discharge device 20. As illustrated in FIGS. 1 and 5, the filling device 100 includes a filling-side buffer portion 102 (buffer), a filling-side mounting/demounting portion 104, and a valve 106. The filling-side buffer portion 102 is provided to buffer an internal pressure variation in the filling device 100, which is caused when the discharge device 20 and the filling device 100 are connected to and separated from each other so as to fill the fluid into the discharge portion 24. The filling-side buffer portion 102 can be formed of a container, such as a tank, or can include the cylinder mechanism 30 in the same way as in the above-mentioned discharge-side buffer portion 22. In this embodiment, the filling-side buffer portion 102 includes an absorber mechanism 110 as illustrated in FIG. 6(d).

Specifically, the absorber mechanism 110 includes a casing 112, a piston 114, and a spring 116, and is configured to be operated through use of the elastic force of the spring 116. The casing 112 is a cylindrical tubular body and includes a connecting portion 118 on one end side in an axis line direction of the casing 112. Further, in the casing 112, the piston 114 can freely slide in the axis line direction of the casing 112. The piston 114 has such a configuration that a piston rod 114b is connected to a piston main body 114a. An inner space of the casing 112 is partitioned into a first camber 120 on one side and a second chamber 122 that communicates to the connecting portion 118 on the other side, through intermediation of the piston main body 114a. The spring 116 is provided in the second chamber 122. Thus, the piston main body 114a is biased to the first chamber 120 side. When the fluid flows in the casing 112 through the connecting portion 118, the piston main body 114a is pushed back toward the second chamber 122 against the biasing force of the spring 116, and thereby the first chamber 120 expands.

As illustrated in FIG. 5, the filling-side mounting/demounting portion 104 has such a configuration that a sealed space forming member 132 is connected to be integrated with a filling-side mounting/demounting portion main body 130. As illustrated in FIG. 5(d), the filling-side mounting/demounting portion main body 130 includes a hollow fitting portion 130a and a connecting portion 130b that is formed so as to be continued from the fitting portion 130a and protrude toward a top surface side. The filling-side connector 134 described later in detail is fitted into the fitting portion 130a so as to be integrated therewith. Further, a sealing member 136, such as an O-ring, is mounted on an outer circumferential portion of the connecting portion 130b.

Further, the filling-side mounting/demounting portion main body 130 includes a communication path 130c formed so as to communicate to the fitting portion 130a. Further, connecting ports 130d and 130e are formed at both ends of the communication path 130c. The connecting portion 118 of the filling-side buffer portion 102 is connected via piping to the connecting port 130d. Further, the valve 106 is connected via piping to the connecting port 130e.

The filling-side connector 134 is combined with the discharge-side connector 82 provided on the discharge device 20 side, to thereby form the connecting device 140 for connecting the discharge device 20 and the filling device 100 to each other. The filling-side connector 134 is a female socket into which the discharge-side connector 82 is plugged. The filling-side connector 134 contains a valve mechanism (not shown), such as a stop valve mechanism. The filling-side connector 134 is fitted into the fitting portion 130a of the filling-side mounting/demounting portion main body 130 so as to be integrated therewith and communicates to the communication path 130c formed in the filling-side mounting/demounting portion main body 130.

As illustrated in FIG. 5, the sealed space forming member 132 is a tubular member to be connected to the top surface side of the filling-side mounting/demounting portion main body 130 in a removable manner. Specifically, the sealed space forming member 132 is integrated with the filling-side mounting/demounting portion main body 130 by inserting bolts 138 in a plurality of (four in this embodiment) bolt insertion holes 132a, which are formed in a circumferential direction of the sealed space forming member 132 so as to extend in an axis line direction thereof, and fastening each bolt 138 in a corresponding screw hole 130f formed through the top surface of the filling-side mounting/demounting portion main body 130. When the filling-side mounting/demounting portion main body 130 and the sealed space forming member 132 are integrated with each other, a positioning pin 142 is mounted through a pin hole (not shown) formed through a bottom surface (filling-side mounting/demounting portion main body 130 side) of the sealed space forming member 132 and a pin hole 130g formed through the top surface side of the filling-side mounting/demounting portion main body 130. With this, the filling-side mounting/demounting portion main body 130 and the sealed space forming member 132 are connected to each other in a state of being positioned so as to have a predetermined positional relationship in the circumferential direction. Further, the filling-side mounting/demounting portion main body 130 and the sealed space forming member 132 are sealed together with the sealing member 136 mounted on the outer circumferential portion of the connecting portion 130b.

The hook-like slit 144 is formed in an upper end portion (end portion on an opposite side to the filling-side mounting/demounting portion main body 130) of the tubular body forming the sealed space forming member 132. The hook-like slit 144 is combined with the pin 84 provided on the discharge device 20 side to form the separation preventing mechanism 150. The separation preventing mechanism 150 is a mechanism for holding the discharge device 20 and the filling device 100 so as not to be separated from each other due to the force to be applied when the fluid is filled into the discharge device 20 from the filling device 100. Specifically, the hook-like slit 144 is a slit having a substantially “L”-shape in a front view and continuously includes a slit portion opened toward the upper end portion of the sealed space forming member 132 and a slit portion formed so as to extend in the circumferential direction of the sealed space forming member 132. Thus, by plugging the discharge-side mounting/demounting portion 26 into the sealed space forming member 132 in a state of positioning the pin 84 provided on the discharge-side mounting/demounting portion 26 of the discharge device 20 with the hook-like slit 144 and rotating the discharge-side mounting/demounting portion 26 in the circumferential direction, the pin 84 can be engaged with the hook-like slit 144 so as not to come off from the hook-like slit 144.

An exhaust port (not shown) is formed in an outer circumferential portion of the sealed space forming member 132. The exhaust port is connected so as to cause the inside and outside of the sealed space forming member 132 to communicate to each other. As illustrated in FIG. 1, the sealed space forming member 132 is connected to a decompression device 148, such as a vacuum pump, through the exhaust port.

The fluid feed source 160 can pump up the fluid from a reservoir 162 storing the fluid and pump the fluid to the filling device 100. The fluid feed source 160 is connected via piping to the valve 106 provided at the filling device 100. Therefore, the feed of the fluid to the filling device 100 can be controlled by appropriately opening or closing the valve 106.

The control device 170 is used for controlling the operation of each component forming the discharge system 10, such as the discharge device 20, the manipulator 90, the filling device 100, and the fluid feed source 160. The control device 170 can control operations, such as the fluid discharge operation of the discharge device 20, the operation of the manipulator 90, and the fluid filling operation performed mainly by the discharge device 20 and the filling device 100.

<<Regarding Operation of Discharge System 10>>

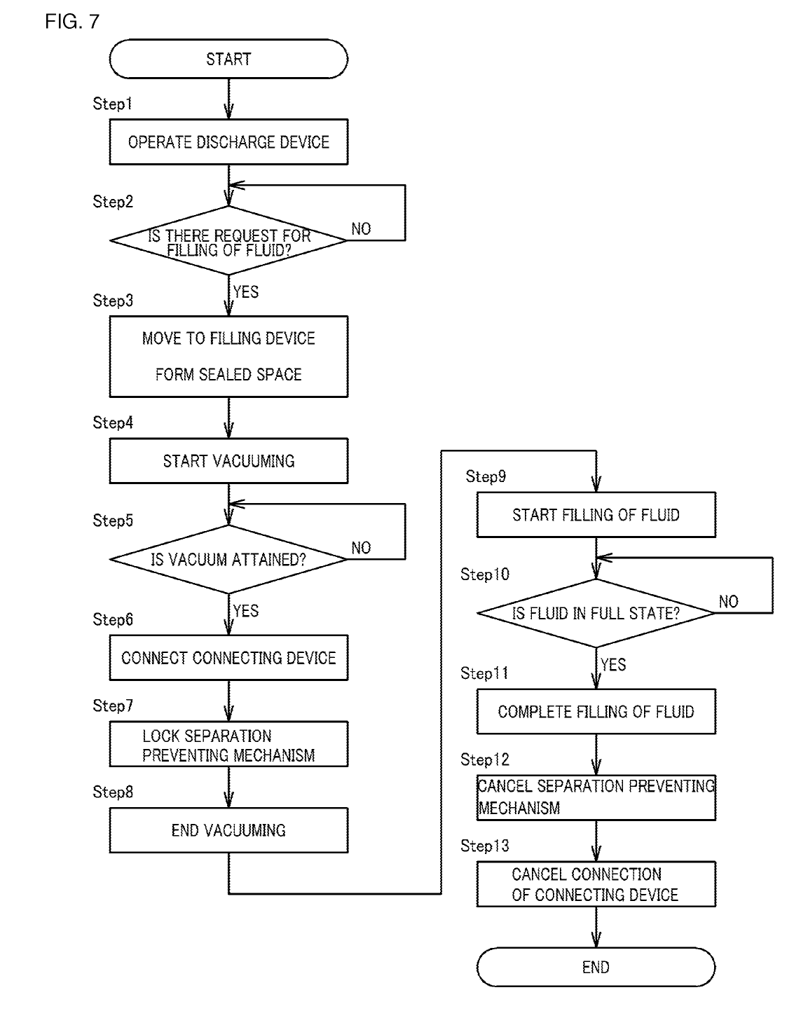

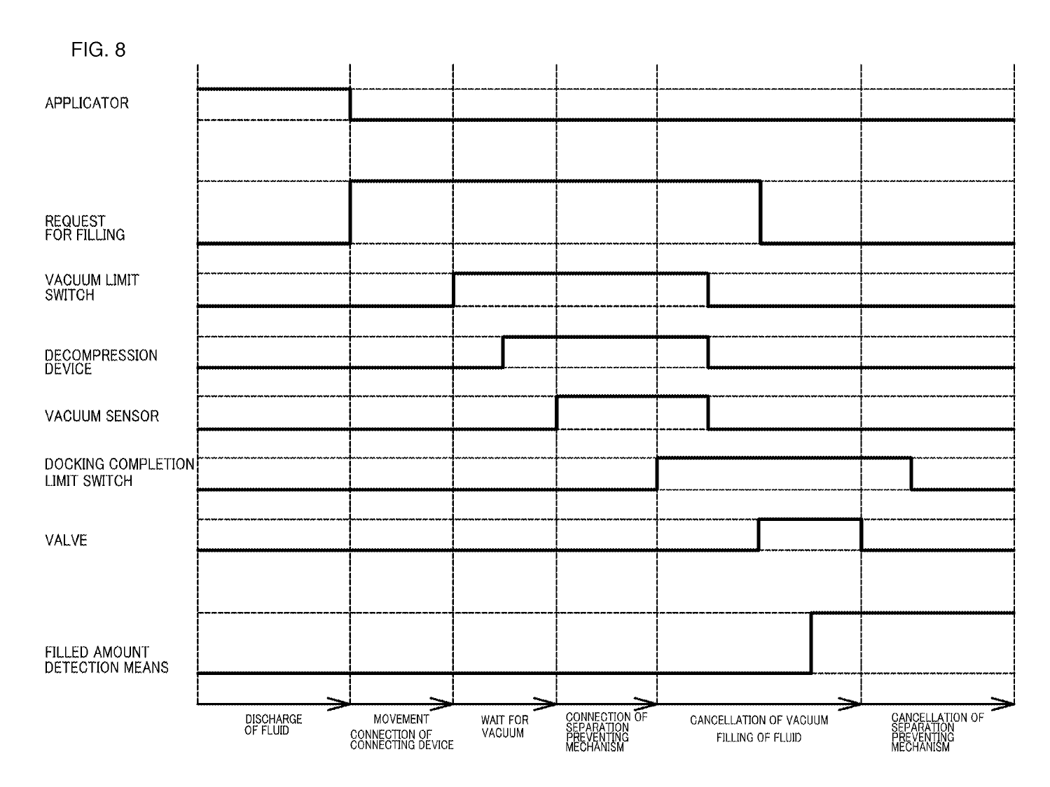

Now, the operation of the discharge system 10 is described mainly with a focus on the fluid filling operation with respect to the discharge device 20 with reference to a flowchart of FIG. 7 and a timing chart of FIG. 8. In the discharge system 10, in Step 1, the discharge device 20 is operated to perform a fluid discharge operation. After the operation of the discharge device 20, in Step 2, in the case where the control device 170 determines that a request for filling the fluid into the discharge device 20 has been output, a control flow proceeds to Step 3. In this case, it can be determined whether or not there is a request for filling the fluid into the discharge device 20 based on various determination criteria. For example, under such a condition that the pressure sensor (not shown) capable of detecting the internal pressure in the discharge-side buffer portion 22 provided in the discharge device 20 shows a value equal to or less than a predetermined pressure, it can be determined that the piston 34 has reached the lower limit position in the discharge-side buffer portion 22, and a request for filling of the fluid has been turned on. Further, in the case of adopting, as the filled amount detection means, an automatic switch that is turned on/off depending on the position of the piston 34, when it is determined that the piston 34 has reached the lower limit position based on the detection result of the automatic switch, it can be determined that a request for filling of the fluid has been turned on.

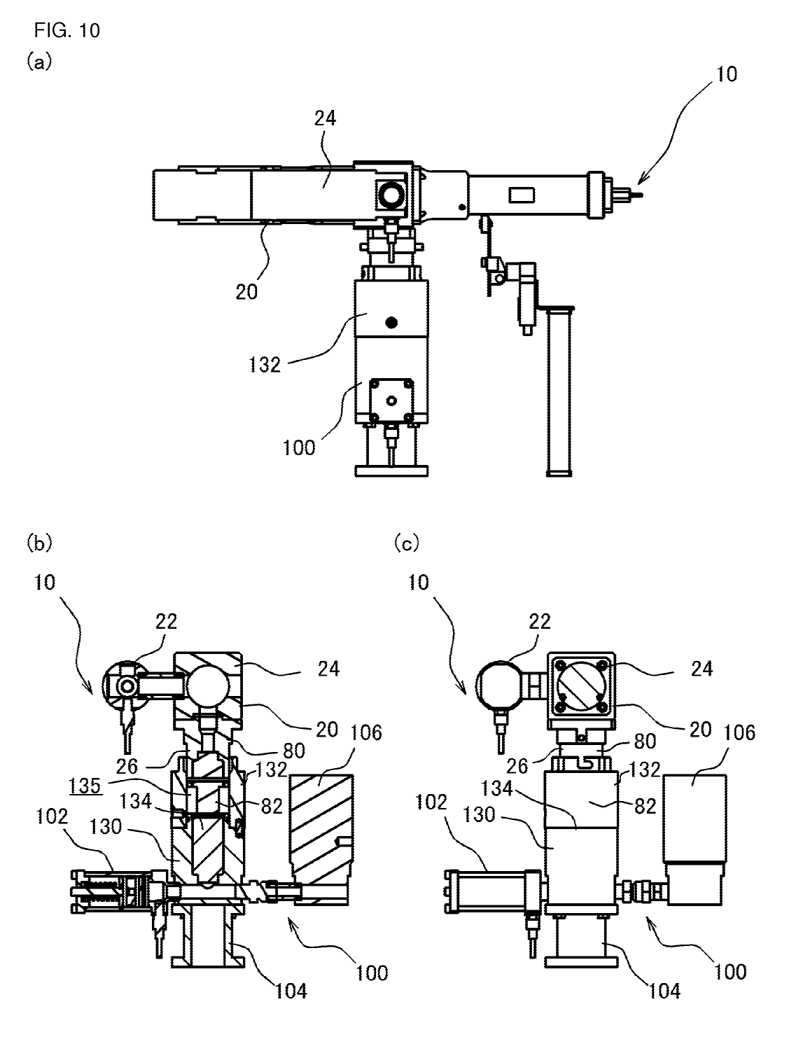

In Step 2, when it is determined that there is a request for filling of the fluid, and the control flow proceeds to Step 3, the manipulator 90 moves the discharge device 20 to the filling device 100 side as illustrated in FIG. 9. After that, as illustrated in FIG. 10, the tubular portion 80a of the discharge-side mounting/demounting portion main body 80 provided on the discharge device 20 side is plugged into the tubular sealed space forming member 132 provided on the filling device 100 side from the upper end portion. In this stage (Step 3), as illustrated in FIG. 10(b), the discharge-side connector 82 on the discharge device 20 side and the filling-side connector 134 are not connected to each other. In this state, on an upper end side of the sealed space forming member 132, a gap between the outer circumferential surface of the tubular portion 80a and an inner circumferential surface of the sealed space forming member 132 is sealed with the sealing member 86 mounted on the outer circumference of the tubular portion 80a. On the other hand, on a lower end side of the sealed space forming member 132, a gap between an outer circumferential surface of the connecting portion 130b and the inner circumferential surface of the sealed space forming member 132 is sealed with the sealing member 136 mounted on the outer circumference of the connecting portion 130b. Thus, in the state of Step 3, a sealed space 135 is formed on an inner side of the sealed space forming member 132, and the discharge-side connector 82 and the filling-side connector 134 are arranged in a disconnected state in the sealed space 135.

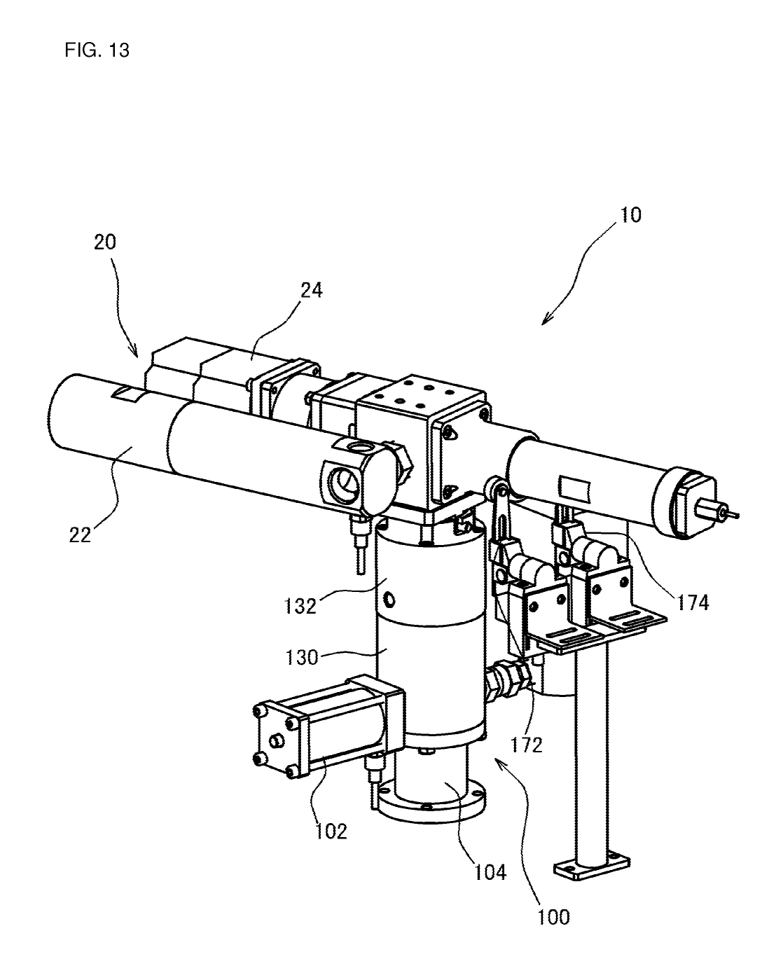

When the sealed space 135 is formed in the sealed space forming member 132 as described above, the control flow proceeds to Step 4. In Step 4, in order to bring the sealed space 135 into a substantially vacuum state, the decompression device 148 connected via piping to an exhaust port 146 of the sealed space forming member 132 is operated to start vacuuming. Note that, the detection of the connected state between the tubular portion 80a and the sealed space forming member 132, which is a trigger to cause the start of vacuuming, can be performed by various methods. Specifically, a vacuum limit switch 172 for detecting the insertion of the tubular portion 80a in the sealed space forming member 132 may be provided at a position adjacent to the filling device 100 as illustrated in FIG. 13, and based on a signal output from the vacuum limit switch 172, the control device 170 can determine that the tubular portion 80a has been inserted in the sealed space forming member 132 to form the sealed space 135.

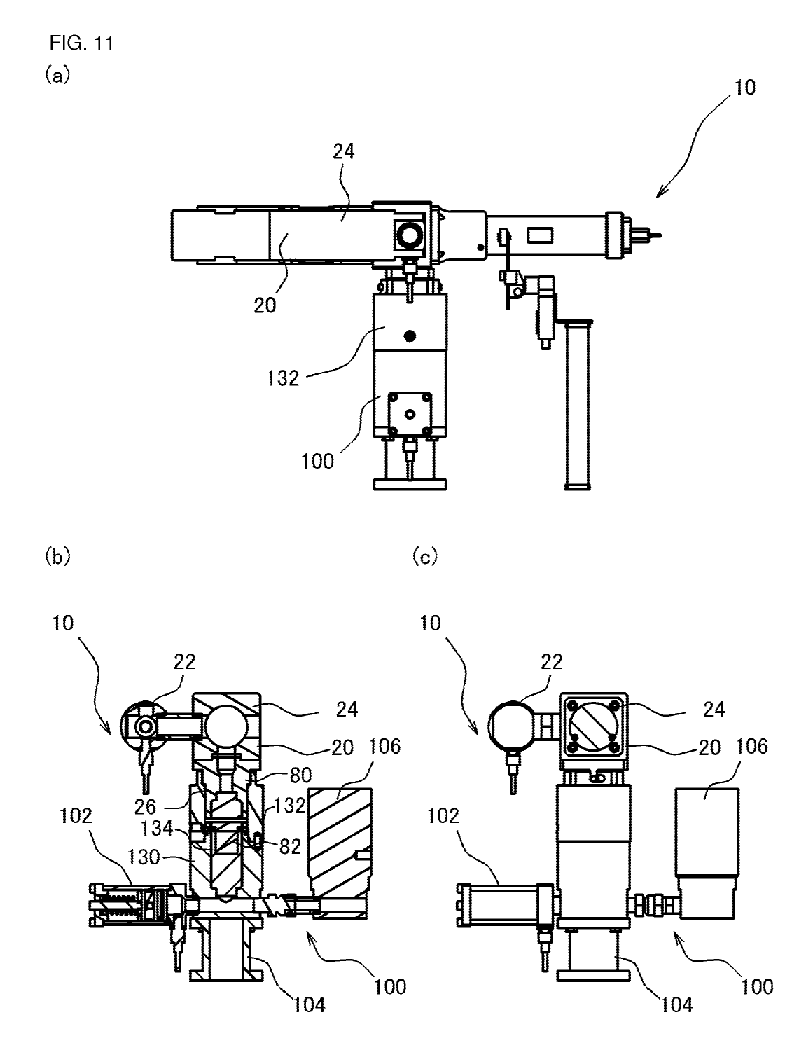

After the start of vacuuming in Step 4, in Step 5, when a vacuum sensor (not shown) for detecting a vacuum degree of the sealed space 135 confirms that the vacuum degree has reached an intended vacuum degree, the control flow proceeds to Step 6. In Step 6, due to the operation control of the manipulator 90 by the control device 170, the discharge device 20 moves in an axis line direction of the discharge-side connector 82 to come close to the filling device 100. In this case, the control device 170 outputs a signal (operation speed control signal) for controlling the operation speed to the manipulator 90 so that the discharge device 20 comes close to the filling device 100 at a predetermined speed V1. With this, as illustrated in FIG. 11, in the sealed space 135, the discharge-side connector 82 and the filling-side connector 134 come close to each other at the speed V1, and thereby the discharge-side connector 82 and the filling-side connector 134 (connecting device 140) are connected to each other.

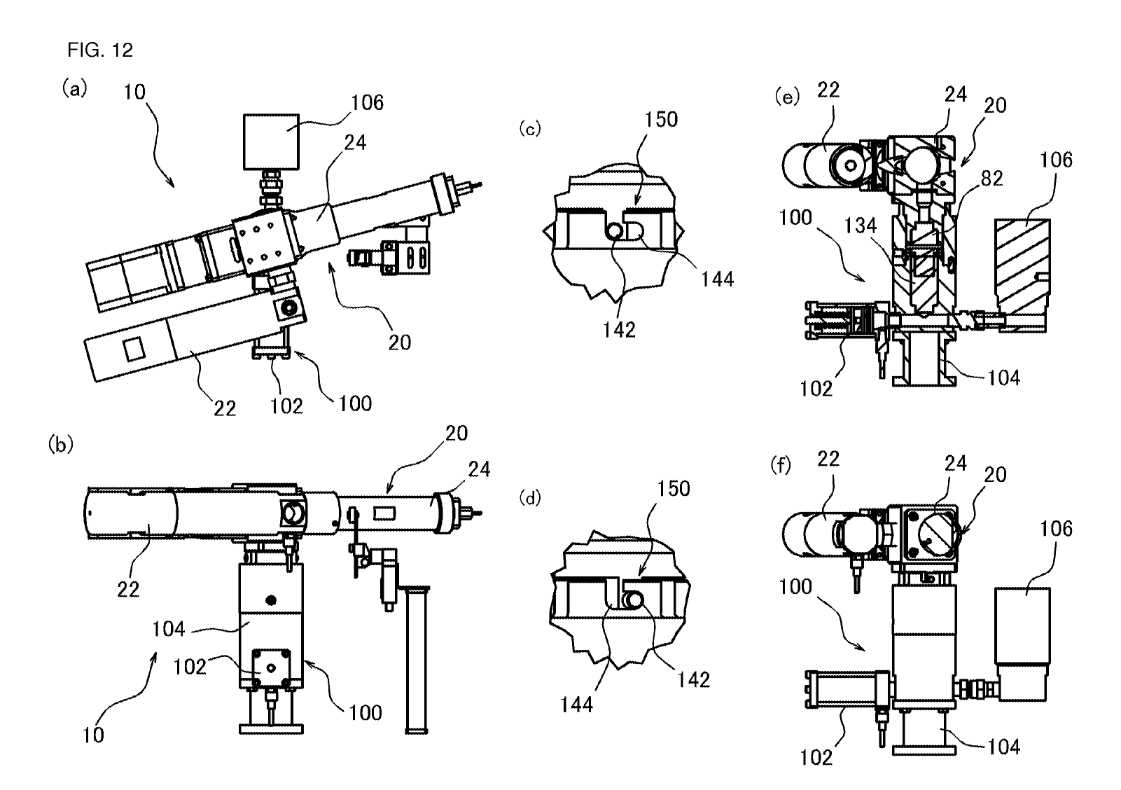

When the connecting device 140 is brought into a connected state, in Step 7, the separation preventing mechanism 150 is brought into a locked state. Specifically, when the discharge-side connector 82 and the filling-side connector 134 are connected to each other in Step 6, the pin 84 provided on an outer circumferential portion of the discharge-side mounting/demounting portion main body 80 also proceeds in the axis line direction of the sealed space forming member 132 to enter the hook-like slit 144 formed in the sealed space forming member 132 as illustrated in FIG. 12(c). In Step 7, the manipulator 90 turns the discharge device 20 in the circumferential direction of the sealed space forming member 132 as indicated by the arrow in FIG. 12(a), and thus the discharge device 20 is rotated as illustrated in FIG. 12(b). In addition, the pin 84 moves along the hook-like slit 144 to be engaged therewith as illustrated in FIG. 12(d). With this, the separation preventing mechanism 150 is brought into a locked state. It can be detected by various methods that the pin 84 has reached the vicinity of a trailing end portion of the hook-like slit 144 to bring the separation preventing mechanism 150 into a locked state. Specifically, a docking completion limit switch 174 for detecting that the discharge device 20 has been rotated up to a position at which the pin 84 reaches the vicinity of the trailing end portion of the hook-like slit 144 may be provided at a position adjacent to the filling device 100 as illustrated in FIG. 13, and based on a signal output from the docking completion limit switch 174, it can be detected whether or not the separation preventing mechanism 150 is in a locked state.

When the connection of the connecting device 140 is completed as described above, and the separation preventing mechanism 150 is brought into a locked state, in Step 8, the decompression device 148 is stopped to end vacuuming. After that, the control flow proceeds to Step 9, and the filling of the fluid from the filling device 100 into the discharge device 20 is started. Specifically, in Step 9, the valve 106 provided in the filling device 100 is opened, and the fluid pumped from the fluid feed source 160 is pumped to the discharge device 20 side through the connecting device 140 formed of the discharge-side connector 80 and the filling-side connector 134. The fluid pumped to the discharge device 20 side is filled into the casing 50 of the discharge portion 24 through the discharge-side mounting/demounting portion 26. In this case, as described above, the discharge-side buffer portion 22 and the filling-side buffer portion 102 are provided in the discharge device 20 and the filling device 100, respectively. Thus, the internal pressure variation caused by the filling of the fluid into the discharge device 20 from the filling device 100 is buffered, and the internal pressure in the discharge device 20 and the filling device 100 can be maintained at a low pressure in the vicinity of the atmospheric pressure.

When the filling of the fluid is started as described above, the control flow proceeds to Step 10, and the control device 170 confirms whether or not the fluid has been filled into the discharge device 20 side in a full state. In this case, as the method of detecting that the fluid has been sufficiently filled into the discharge device 20 and the like, there may be given various methods. Specifically, under such a condition that the pressure sensor (not shown) for detecting the internal pressure in the discharge-side buffer portion 22 of the discharge device 20 shows a value equal to or more than a predetermined pressure, it can be determined that the fluid has been sufficiently filled, and a request for filling has been turned off. Further, in the case of adopting, as the filled amount detection means, an automatic switch that is turned on/off depending on the position of the piston 34, when the piston 34 has reached a detection region of the automatic switch provided at the upper limit position, and the automatic switch at the upper limit position is turned on, it can be determined that a request for filling of the fluid has been turned off.

In Step 10, when it is confirmed that the fluid has been filled into the discharge device 20 in a full state, the control flow proceeds to Step 11, and the valve 106 is closed. Thus, the filling of the fluid into the discharge device 20 from the filling device 100 is completed. When the filling of the fluid is completed as described above, the control flow proceeds to Step 12, and the separation preventing mechanism 150 is cancelled. Specifically, the manipulator 90 is operated to turn the discharge device 20 in a direction opposite to the direction in the case where the separation preventing mechanism 150 is brought into a locked state in Step 7, and thereafter the discharge device 20 is separated from the filling device 100 in an axis line direction. Thus, when the pin 84 comes off from the hook-like slit 144, the lock of the separation preventing mechanism 150 is cancelled.

When the lock cancellation of the separation preventing mechanism 150 is completed, the control flow proceeds to Step 13. In Step 13, the discharge device 20 further moves in a direction in which the discharge device 20 is separated from the filling device 100 in the axis line direction. In this case, the control device 170 outputs a signal (operation speed control signal) for controlling the operation speed to the manipulator 90 so that the discharge device 20 is separated from the filling device 100 at a predetermined speed V2. The separation speed V2 is set to be equal to or less than the connection speed V1 in Step 6 described above (|V|≦|V2|). With this, the discharge-side connector 82 and the filling-side connector 134 are separated from each other at the speed V2 equal to or less than the speed at a time of the connecting operation, and the discharge-side connector 82 comes off from the filling-side connector 134 to cancel the connection. Accordingly, a series of operation flows are completed.

As described above, in the discharge system 10 according to this embodiment, the connecting operation of connecting the discharge-side connector 82 on the discharge device 20 side and the filling-side connector 134 on the filling device 100 side to each other so as to fill the fluid into the discharge device 20 is performed in the sealed space 135 that is brought into a negative pressure state by the decompression device 148. This configuration can reduce the risk in that air may enter the discharge device 20 and the filling device 100 during the connecting operation. Thus, according to the discharge system 10, a discharge failure of the fluid caused by the mixing of air can be minimized.

In the discharge system 10 according to this embodiment, the discharge device 20 and the filling device 100 include the discharge-side buffer portion 22 and the filling-side buffer portion 102, respectively, as the buffer for buffering an internal pressure variation caused by the connection and separation of the discharge device 20 and the filling device 100. With this, such a situation can be suppressed that the insides of the discharge device 20 and the filling device 100 are brought into a negative pressure during the connecting and separating operations of the discharge device 20 and the filling device 100, and thereby a discharge failure of the fluid caused by the entry of air into the discharge device 20 and the filling device 100 can be further reliably suppressed.

Further, in the discharge system 10, the discharge-side buffer portion 22 including the cylinder mechanism is provided as the buffer on the discharge device 20 side. In the discharge-side buffer portion 22, the cylinder 34 ascends along with the inflow of the fluid into the second chamber 44 during the filling operation, and the capacity of the second chamber 44 increases. By operating the discharge-side buffer portion 22 as described above, such a situation can be avoided that the inside of the discharge device 20 is brought into a negative pressure, and thereby the entry of air into the discharge device 20 can be suppressed. With this, a discharge failure of the fluid can be suppressed further reliably.

Further, in the discharge system 10 according to this embodiment, the filling-side buffer portion 102 including the absorber mechanism that is operated through use of the biasing force of the spring 116 is provided as the buffer on the filling device 100 side. This configuration can suppress such a situation that the inside of the filling device 100 is brought into a negative pressure during the connection and separation of the discharge device 20 and the filling device 100, to thereby suppress the entry of air into the filling device 100.

In this embodiment, although there is exemplified a case in which the buffer including the cylinder mechanism is adopted as the discharge-side buffer portion 22 on the discharge device 20 side, and the buffer including the absorber mechanism is provided as the filling-side buffer portion 102 on the filling device 100 side, the present invention is not limited thereto. Specifically, as the buffer to be provided on the discharge device 20 side, a member comparable to the filling-side buffer portion 102 including the absorber mechanism may be provided. Similarly, as the buffer to be provided on the filling device 100 side, a member comparable to the discharge-side buffer portion 22 including the cylinder mechanism may be provided. Further, one or both of the discharge-side buffer portion 22 and the filling-side buffer portion 102 may not be provided.

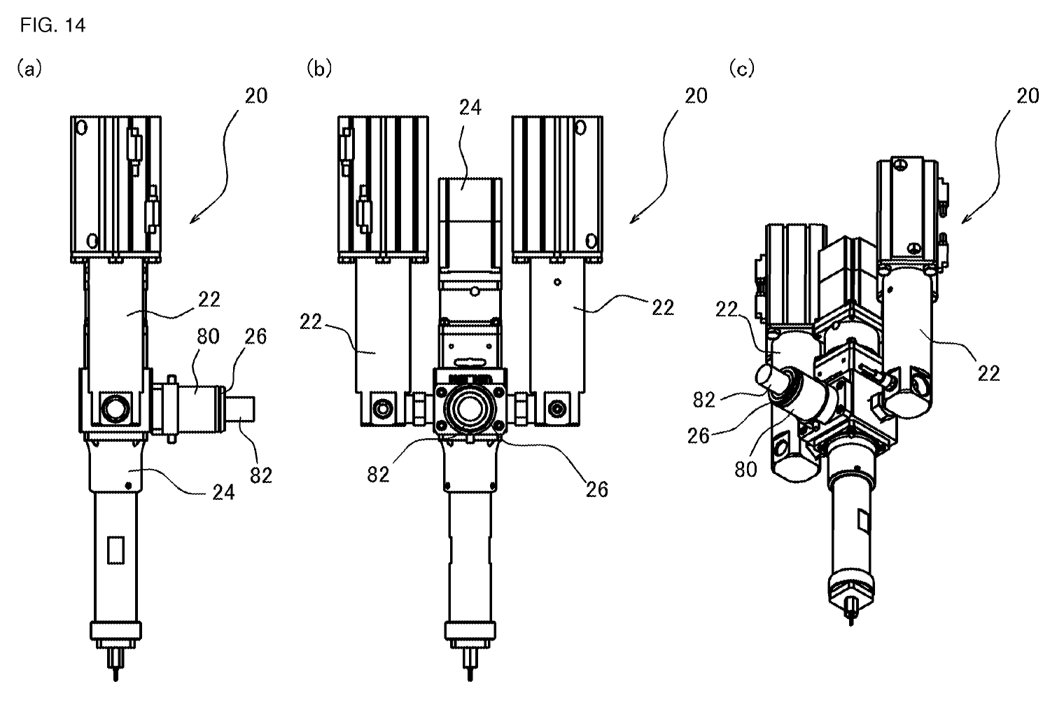

In this embodiment, although there is exemplified a case in which one buffer forming the discharge-side buffer portion 22 is provided in the discharge device 20, and one buffer forming the filling-side buffer portion 102 is provided in the filling device 100, the present invention is not limited thereto. Specifically, as illustrated in FIG. 14, the discharge device 20 may be configured to include two or more buffers forming the discharge-side buffer portion 22.

In this embodiment, although the discharge-side buffer portion 22 including the cylinder mechanism and the discharge-side buffer portion 22 including the absorber mechanism are exemplified as examples of the buffers to be provided in the discharge device 20 and the filling device 100, the present invention is not limited thereto, and the buffers may be formed of another type of accumulator or a tank capable of allowing outflow and inflow of the fluid. This configuration also suppresses such a situation that the insides of the discharge device 20 and the filling device 100 are brought into a negative pressure during the connecting and separating operations, to thereby avoid a discharge failure of the fluid caused by the mixing of air.

The discharge system 10 according to this embodiment includes the separation preventing mechanism 150 formed of the positioning pin 142 and the hook-like slit 144. With this, the discharge device 20 can be reliably prevented from being separated from the filling device 100 in a state of being connected to the filling device 100 so as to fill the fluid into the discharge device 20. Note that, the separation preventing mechanism 150 exemplified in this embodiment is merely an example, and a catch typified by a related-art well-known ball catch, a hook, a fastener, or the like may also be used as the separation preventing mechanism 150.

The discharge system 10 adopts the uniaxial eccentric screw pump as the discharge portion 24 of the discharge device 20. Therefore, the fluid filled into the discharge device 20 from the filling device 100 can be discharged quantitatively and stably without pulsating or the like. Further, in the discharge system 10, a discharge failure of the fluid caused by the mixing of air hardly occurs. Thus, the discharge system 10 has extremely high discharge performance of the fluid and can be preferably used for purposes of applying a fluid, such as a sealant or an adhesive, to various components in an automobile assembly plant or the like.

In the discharge system 10 described above, the axis line direction of the discharge-side connector 82 provided in the discharge-side mounting/demounting portion 26 of the discharge device 20 intersects with (is substantially orthogonal to) the axis line direction of the discharge portion 24. Therefore, when the discharge device 20 is connected to the filling device 100 set on a floor, the discharge device 20 is lowered to the filling device 100 side in a state in which the discharge portion 24 is held in a substantially horizontal posture, and the discharge-side connector 82 is pressed into the filling-side connector 134. Thus, in order to enable the discharge-side connector 82 to be pressed into the filling-side connector 134 accurately without involving the complicated operation of the manipulator 90 in the case where the discharge device 20 is configured as described above, it is desired that an arm of the manipulator 90 be mounted at a position on the axis line of the discharge-side connector 82 in the discharge portion 24.

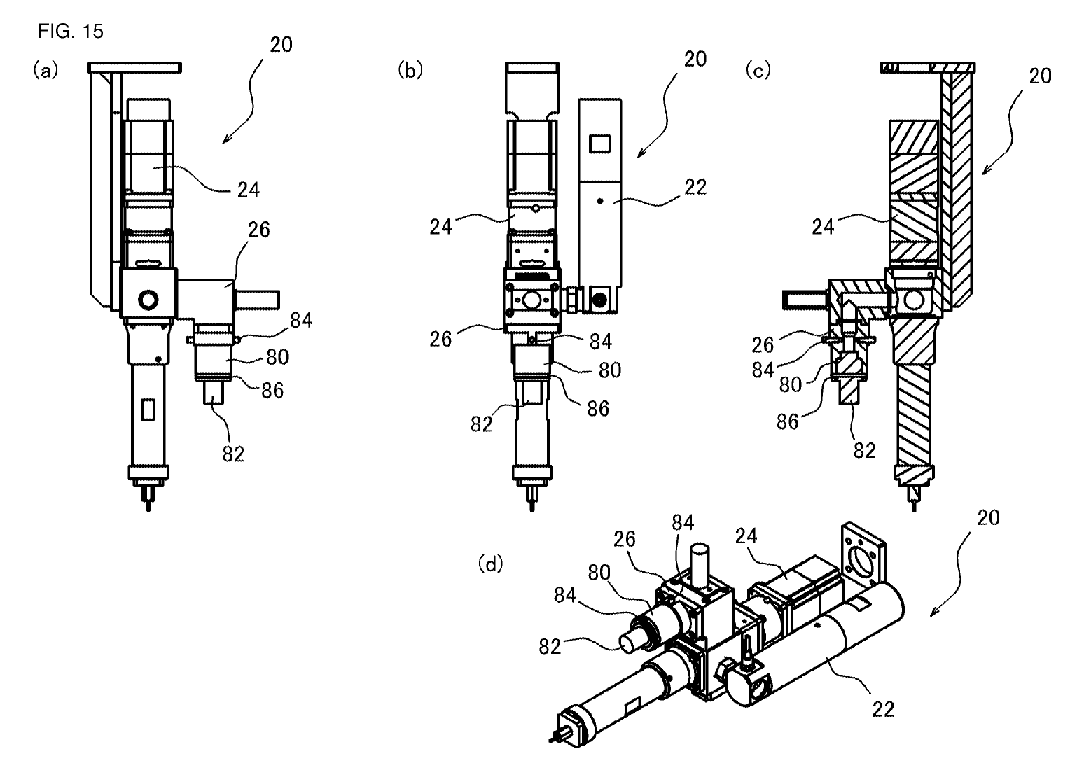

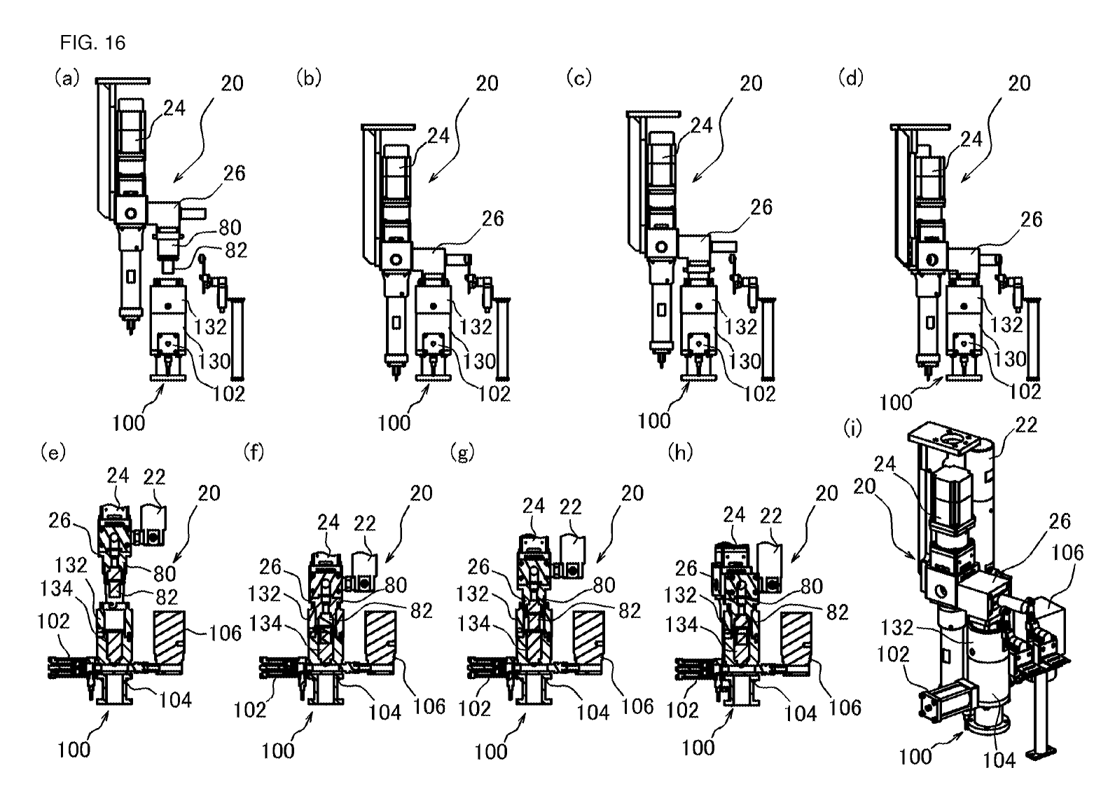

In contrast, in the case where the arm of the manipulator 90 is mounted on a portion of the axis line of the discharge portion 24, such as an upper end portion of the discharge portion 24, it is desired that the axis line direction of the discharge-side connector 82 be arranged to be along (in the illustrated state, substantially parallel to) the axis line direction of the discharge portion 24 as illustrated in FIGS. 15. With such a configuration, as illustrated in FIGS. 16(a) to 16(i), the discharge device 20 is lowered to the filling device 100 side in a state in which the discharge portion 24 is held in a substantially vertical posture, and the discharge-side connector 82 is pressed into the filling-side connector 134 without involving the complicated operation of the manipulator 90 so as to connect the discharge-side connector 82 and the filling-side connector 134 to each other. Thus, the filling operation of the fluid can be performed.

Further, in the discharge system 10 according to this embodiment, the sealed space forming member 132 is removed from the filling-side mounting/demounting portion main body 130 by removing the bolts 138 on the filling device 100 side, and thereby maintenance, such as cleaning of the filling-side connector 134, can be performed. Note that, in this embodiment, although there is exemplified a case in which the sealed space forming member 132 can be removed, the present invention is not limited thereto, and the filling-side mounting/demounting portion main body 130 and the sealed space forming member 132 may be integrated with each other.

Note that, in the discharge system 10 according to this embodiment, there is exemplified a case in which the separation speed V2 of the discharge device 20 and the filling device 100 is controlled to be equal to or less than the connection speed V1 thereof (|V1|≦|V2|), based on the following finding: when the connecting operation and the separating operation of the discharge device 20 and the filling device 100 are performed so as to fill the fluid into the discharge device 20, in the case where the operation speed at a time of the separating operation is higher than the operation speed at a time of the connecting operation, the fluid cannot be sufficiently scraped off in the connecting device 140 to leak and adhere to an outside. However, such a control is not necessarily performed. That is, in the case where it is not necessary to consider the outside leakage of the fluid and the like in the connecting device 140, or another measure is taken for the leakage of the fluid, the separation speed V2 of the discharge device 20 and the filling device 100 may be set to be higher than the connection speed V1 thereof.

### INDUSTRIAL APPLICABILITY

The application system of the present invention can be used preferably for purposes of applying a fluid, such as a sealant or an adhesive, to various components in an automobile assembly plant or the like, filling a fluid, such as grease, into a container, and the like.

### REFERENCE SIGNS LIST

10 discharge system
20 discharge device
22 discharge-side buffer portion
32 casing
34 piston
36 driving source
42 first chamber
44 second chamber
52 rotor
54 stator
82 discharge-side connector
100 filling device
102 filling-side buffer portion
112 casing
114 piston
116 spring
120 first chamber
122 second chamber
132 sealed space forming member
134 filling-side connector
135 sealed space
140 connecting device
148 decompression device
150 separation preventing mechanism

1. A discharge system, comprising:
a discharge device capable of discharging a fluid; and
a filling device capable of filling the fluid into the discharge device,
the discharge system being capable of filling the fluid into the discharge device side from the filling device side by connecting a discharge-side connector mounted on the discharge device side and a filling-side connector mounted on the filling device side to each other in a negative pressure environment.

2. A discharge system according to claim 1, further comprising:
a sealed space forming member capable of forming a sealed space by causing the discharge-side connector and the filling-side connector to be inserted into the sealed space forming member; and
a decompression device for decompressing an inside of the sealed space,
wherein the discharge-side connector and the filling-side connector are capable of being connected to each other under a state in which the inside of the sealed space is brought into the negative pressure environment by the decompression device.

3. A discharge system according to claim 1, wherein the discharge device and/or the filling device comprises a buffer for buffering an internal pressure variation caused by connection and/or separation of the discharge device and the filling device.

4. A discharge system according to claim 3,
wherein the buffer comprises an absorber mechanism comprising a casing, a piston mounted in the casing in a slidable manner, and biasing means for biasing the piston, and
wherein an inside of the casing is partitioned by the piston into a first chamber and a second chamber that allows outflow and inflow of the fluid, and the piston is biased by the biasing means in a direction of reducing a capacity of the second chamber.

5. A discharge system according to claim 3,
wherein the buffer comprises a cylinder mechanism comprising a casing, a piston mounted in the casing in a slidable manner, and a driving source for slidably driving the piston, and
wherein an inside of the casing is partitioned by the piston into a first chamber and a second chamber that allows outflow and inflow of the fluid, and a capacity of the second chamber is capable of being varied by operating the driving source.

6. A discharge system according to claim 3, wherein the buffer comprises a tank capable of allowing outflow and inflow of the fluid.

7. A discharge system according to claim 1, further comprising a separation preventing mechanism for preventing separation of the discharge device connected to the filling device.

8. A discharge system according to claim 1, wherein the discharge device comprises a uniaxial eccentric screw pump comprising: an external thread-shaped rotor configured to receive power to rotate eccentrically; and a stator having an inner circumferential surface formed into an internal thread shape.

9. A discharge system according to claim 2, wherein the discharge device and/or the filling device comprises a buffer for buffering an internal pressure variation caused by connection and/or separation of the discharge device and the filling device.

10. A discharge system according to claim 4,
wherein the buffer comprises a cylinder mechanism comprising a casing, a piston mounted in the casing in a slidable manner, and a driving source for slidably driving the piston, and
wherein an inside of the casing is partitioned by the piston into a first chamber and a second chamber that allows outflow and inflow of the fluid, and a capacity of the second chamber is capable of being varied by operating the driving source.

11. A discharge system according to claim 4, wherein the buffer comprises a tank capable of allowing outflow and inflow of the fluid.

12. A discharge system according to claim 5, wherein the buffer comprises a tank capable of allowing outflow and inflow of the fluid.
